(19) United States
(12) Patent Application Publication
(10) Pub. No.: US 2026/0170465 A1
(43) Pub. Date: Jun. 18, 2026

(54) GIVING GIFTS AFTER PASSING

(71) Applicant: Nicholas Bruno, Hilton Head, SC (US)

(72) Inventor: Nicholas Bruno, Hilton Head, SC (US)

(21) Appl. No.: 19/534,998

(22) Filed: Feb. 10, 2026

(51) Int. Cl. G06Q 10/1093; G06Q 20/10; G06Q 20/24; G06Q 20/40; G06Q 30/06; G06Q 30/0601

(52) U.S. Cl. CPC G06Q 10/1093; G06Q 20/10; G06Q 20/24; G06Q 20/40; G06Q 30/06; G06Q 30/0601

(57) ABSTRACT

An individual creates an account with the intention of ensuring that, after their death, one or more non-monetary gifts will be delivered to a chosen recipient over a defined period of time, with the specific gifts being selected either by the account holder in advance or by the recipient themselves.

### TECHNICAL FIELD

The present disclosure relates generally to posthumous services and, more particularly, to systems and methods for arranging, selecting, and delivering non-monetary gifts to designated recipients after a grantor's death.

### BACKGROUND ART

Various services exist for handling posthumous distributions. For example, trust arrangements and similar financial instruments permit the distribution of cash allotments at predetermined times, while other services enable the delivery of messages or notes following an individual's death. These existing services focus primarily on monetary transfers or the transmission of communications and do not provide flexible mechanisms for arranging the selection and delivery of tangible or non-monetary gifts posthumously. There is demand for a service that allows an individual to prearrange the posthumous delivery of non-monetary gifts, where the gifts may be chosen either by the grantor or, at the grantor's election, by the designated recipient, from defined categories and price ranges, and delivered according to configurable time frames and duration.

### DETAILED DESCRIPTION

The innovation provides a service and method that enables an individual (the Account Holder) to establish and fund an account for arranging the posthumous delivery of non-monetary gifts to one or more designated recipients. The Account Holder registers with the service and deposits funds into the account to cover the cost of the selected gifts, applicable taxes, shipping, and service fees of the posthumous delivery. During account setup the Account Holder designates recipient information, specifies one or more delivery dates, and, where applicable, indicates the duration for any recurring deliveries. Delivery dates may be calendar dates, dates relative to the Account Holder's death (for example, anniversaries or birthdays following death), or repeating intervals specified as a number of years, months, or an otherwise defined schedule. Recipient information can include a recipient's name, contact information, physical address, and any alternate contacts to be used if the primary recipient cannot be reached.

The Account Holder selects posthumous delivery of gifts in one of two principal manners. (1) The Account Holder chooses one or more specific gift items from categories offered through the service, selecting the price range and options presented by the service's catalog. (2) The Account Holder authorizes the recipient to select a gift within a defined category and price range at or before the scheduled delivery date; in this case the service retains the funds and issues the recipient a voucher, gift card, or selection link that limits choices to the authorized category and price range. The service supports a variety of gift types, including physical goods, digital goods that can be delivered electronically, experience vouchers, charitable donations made in the recipient's name, and combinations of these. The Account Holder can specify gift presentation preferences, instructions to accompany the gift, and whether the gift will be labeled explicitly as being delivered on behalf of the deceased Account Holder.

Funds held in the account are managed to ensure that the selected gifts can be procured and delivered at the scheduled time. The service places the funds in a secure holding arrangement and uses them to procure the gifts either by pre-purchasing items, reserving items, or by retaining the funds to pay vendors when delivery is executed. If pre-purchase is used, the service stores or coordinates delivery to the recipient on the scheduled date. If vendor payment is deferred until posthumous delivery, the service transmits payment to the vendor upon confirmation of shipment. The account includes options for handling surplus funds, such as returning remaining balances to a designated beneficiary, donating to a chosen charity, or retaining funds for future scheduled gifts.

Delivery of gifts is triggered after the service confirms the Account Holder's death according to the service's verification procedures. Verification procedures are configurable and can include receipt and validation of an official death certificate, confirmation from a designated executor or trustee, cross-referencing public death records, or confirmation from a funeral home or other authorized third party. The service records the method and evidence of confirmation and restricts release of gifts until verification is complete. Upon verification, the service executes the scheduled posthumous deliveries on the specified dates; for recurring schedules, the service repeats the procurement and delivery process for any occurrence until the specified duration elapses or until the account's instructions or funds indicate termination. The gift is sent with documentation or labeling that identifies the gift as being delivered on behalf of the deceased Account Holder, unless the Account Holder expressly instructs otherwise.

The system provides mechanisms to handle changes. If a designated recipient cannot be located, is deceased, or declines the posthumous gift, the service follows alternate instructions previously provided by the Account Holder, which may include delivering to an alternate recipient, converting the gift to a charitable donation, issuing a refund to the Account Holder's estate, or holding the gift pending further instructions from an authorized representative. The Account Holder can update recipient designations, gift selections, delivery schedules, and funding while alive, subject to any vendor or scheduling constraints. The service implements authentication and authorization controls, encrypted storage of sensitive data, and procedures to comply with applicable privacy and financial regulations.

The innovation can be implemented using a web-based or mobile application interface that guides the Account Holder through account creation, funding, recipient designation, gift selection, and schedule. The back-end coordinates with payment processors, item systems, shipping providers, and third-party vendors to execute deliveries. Alternative implementations include manual or assisted enrollment mediated by customer service agents and integration with estate planning or funeral service providers. These trait's ensure that the Account Holder's intent to provide posthumous non-monetary gifts after death is fulfilled reliably, securely, and on the schedule specified by the Account Holder.

It is to be understood that the above description is intended to be illustrative, and not restrictive. For example, the above-described embodiments (and/or aspects thereof) may be used in combination. Many other embodiments will be apparent to those of skill in the art upon reviewing the above description. The scope, therefore, is determined with reference to the appended claims, along with the full scope of equivalents to which such claims are entitled. In the appended claims, the term “including” is used as the plain-English equivalents of the respective terms “comprising.” Also, in the following claims, the terms “including” are open-ended, that is, a system, device, article, or process that includes elements in addition to those listed after such a term in a claim are still deemed to fall within the scope of that claim. The Abstract of the Disclosure is provided to comply with 37 C.F.R. &sect; 1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, various features may be grouped together to streamline the disclosure. This method of disclosure is not to be interpreted as reflecting an intention that the claimed embodiments involve more features than are expressly recited in their claim. The following claims reflect innovative subject matter that may lie in a single disclosed representation. Thus, the following claims are hereby incorporated into the Detailed Description, with respective claims standing on their own as a separate exemplar.

1. Posthumous delivery of non-monetary gifts means that an account holder selects a category and price range for a gift to be delivered upon verification procedures. A designated recipient may receive gifts at recurring intervals defined by a stated number of years, months, or another predetermined schedule.

2. Posthumous delivery of non-monetary gifts means that an account holder selects a category and price range for a gift to be delivered upon verification procedures. A designated recipient is authorized to select the non-monetary gift from a defined category and price range. These gifts may be made at recurring intervals defined by a stated number of years, months, or another predetermined schedule.
